(19) United States
(12) Patent Application Publication
(10) Pub. No.: US 2012/0121029 A1
(43) Pub. Date: May 17, 2012

(54) NEAR END CROSS TALK REDUCTION FOR A MIMO SYSTEM

(75) Inventors: Thomas Ahrndt, Ottbrunn (DE); Roberto Bianchi, Erlangen (DE); Bernhard Schweyer, Bad Kohlgrub (DE)

(73) Assignee: NOKIA SIEMENS NETWORKS OY, ESPOO (FI)

(21) Appl. No.: 13/383,923

(22) PCT Filed: Jul. 13, 2009
(86) PCT No.: PCT/EP09/58917

§ 371 Date: Feb. 3, 2012

(51) Int. Cl. H04B 15/00; H04L 27/28

(52) U.S. Cl. 375/260; 375/285

(57) ABSTRACT

A method and a device perform data processing in a network element of a MIMO system, wherein near end cross talk is reduced at a collaborative network element of the MIMO system. A frequency band is at least partially used for upstream and downstream traffic. Furthermore, an interference canceller and a communication system are suggested.

The invention relates to a method and to a device for data processing in a network element of a MIMO system.

DSL or xDSL is a family of technologies that provide digital data transmission over the wires of a local telephone network.

Asymmetric Digital Subscriber Line (ADSL) is a form of DSL, a data communications technology that enables faster data transmission over copper telephone lines than a conventional voice band modem can provide. Such fast transmission is achieved by utilizing frequencies that are normally not used by a voice telephone call, in particular, frequencies higher than normal human hearing.

VDSL (Very High Speed DSL) is an xDSL technology providing faster data transmission over a single twisted pair of wires. High bit rates are achieved at a range of about 300 meters (1000 ft), which allows for 26 Mbit/s with symmetric access or up to 52 Mbit/s in downstream - 12Mbit/s in upstream with asymmetric access.

Currently, standard VDSL uses up to 4 different frequency bands, two for upstream (from the client to the telecom provider) and two for downstream.

According to its high bandwidth, VDSL is capable of supporting applications like HDTV, as well as telephone services (e.g., Voice over IP) and general Internet access, over a single connection.

VDSL2 (Very High Speed Digital Subscriber Line 2) is also an access technology that exploits the existing infrastructure of copper wires that were originally used for plain old telephone service (POTS). It can be deployed from central offices (COs), from fiber-fed cabinets preferably located near customer premises, or within buildings. VDSL2 is designed to support the wide deployment of Triple Play services such as voice, video, data, high definition television (HDTV) and interactive gaming. VDSL2 enables operators and carriers to gradually, flexibly, and cost efficiently upgrade existing xDSL infrastructure.

ITU-T G.993.2 (VDSL2) is an enhancement to G.993.1 (VDSL) that permits the transmission of asymmetric and symmetric (full duplex) aggregate data rates up to 200 Mbit/s on twisted pairs using a bandwidth up to 30 MHz.

Such xDSL wide band modulation schemes are susceptive to crosstalk interference that is introduced to the twisted pair transmission line and received by the modem.

Crosstalk occurs when wires are coupled, in particular between wire pairs of the same or a nearby bundle that are used for separate signal transmission. Hence, data signals from one or more sources can be superimposed on and contaminate a data signal. Crosstalk comprises a near-end crosstalk (NEXT) and a far-end crosstalk (FEXT).

Based on such crosstalk, data signals transmitted over twisted-pair lines can be considerably degraded by crosstalk interference generated on one or more adjacent twisted-pair phone lines in the same and/or a nearby multi-core cable or bundle. With an increasing transmission speed, this problem even deteriorates, which may significantly limit a maximum data rate to be transmitted via a single line.

A multiple-input-multiple-output system (hereinafter referred to as MIMO system) is of significant importance in modern communication technology. Such MIMO system allows modeling crosstalk interference of a telecommunication system.

However, a MIMO system to be fully calculated implies a huge processing effort which may be limited due to existing hardware.

xDSL (e.g., ADSL, ADSL2, ADSL2+, VDSL, VDSL2 etc.) in particular utilizes Discrete Multi-Tone (DMT) modulation as transmission technique. Said DMT modulation is similar to Orthogonal Frequency Division Multiplexing (OFDM).

DSL also uses Frequency Division Duplexing (FDD) thereby allocating different frequency bands for different transmission directions (upstream/uplink and downstream/downlink) signals. Due to this separation of bandwidth, interference between upstream/uplink and downstream/downlink signals is reduced and/or minimized, i.e. echoes (interference from a send signal to a receive signal or a network element) and Near-End crosstalk (interference from other modems' send signals on an own receive signal) are avoided and/or reduced.

However this approach significantly limits the spectral efficiency and flexibility of the DSL systems, since the band used for upstream transmission is not available for downstream transmission and vice versa.

DSM L3 is a technology mainly affecting VDSL2 modems. It is used to enhance the performance of VDSL2 modems by reducing mutual interference. This is achieved by coordination of sending and receiving.

Existing solutions still bear the disadvantage of NEXT, which significantly deteriorates a performance of overlapping DSL systems.

The problem to be solved is to overcome the disadvantages and limitations stated above and in particular to enhance a spectral efficiency of MIMO system.

The MIMO system applicable may in particular be a MIMO wireless systems or a xDSL system with DSM L3.

This problem is solved according to the features of the independent claims. Further embodiments result from the depending claims.

In order to overcome this problem, a method for data processing in a network element of a MIMO system is suggested,
wherein near end cross talk is reduced at a collaborative network element of the MIMO system; and
wherein a frequency band is at least partially used for upstream and downstream traffic.

Hence, the network element of the MIMO system may be the collaborative network element.

The approach provided allows utilizing a frequency band for both upstream traffic and downstream traffic. The MIMO system may be a wireless or a wireline communication system. The MIMO system may in particular comprise a CO, a DSLAM or an ONU connected to several CPEs, wherein the modems at the CO, DSLAM or ONU may be utilized as a cooperation area (covered by said collaborative network element). Near end crosstalk in particular is based on interference from downstream traffic to upstream traffic.

As the collaborative network element is aware of the downstream traffic, the impact (“echo”) of said downstream traffic to the upstream traffic can be identified and reduced or compensated at the collaborative network element. This advantageously allows for a frequency band being used for upstream and downstream traffic as any interference between upstream and downstream traffic can be cancelled (or reduced to a significant extent) at the collaborative network element.

The approach provided herein may apply to wireless or wireline communication systems. In particular, all communication systems with two or more collaborating transmitters and/or receivers may utilize the approach presented herein.

Collaboration between transmitters and/or receivers helps avoiding far-end interference (FEI), reducing disturbance and thus enhancing the system's performance in terms of data-rate, margin, reach, or the like.

In an embodiment, the frequency band is completely used for upstream and downstream traffic.

Hence, a common frequency band can be used for upstream and for downstream traffic.

In another embodiment, the upstream traffic is conveyed with a reduced power compared to the downstream traffic.

With the upstream traffic being conveyed at low power, a signal-to-noise ratio is enhanced by the means of echo-cancellation.

In a further embodiment, the near end cross talk is reduced by determining an estimate of multi-user echoes, in particular by determining an estimate of at least one downstream send signal that is reflected into at least one upstream receive signal.

Such estimate can be determined by utilizing a MIMO channel estimation algorithm, e.g., a LMS algorithm, a LMA or a RLS algorithm.

In a next embodiment, the estimate of multi-user echoes E P is determined based on a stochastic gradient algorithm.

It is also an embodiment that
an error signal e^{k,n}=F_{j,m}^{k,n}·x^{j,m}−E_{j,m}^{k,n}·x^{j,m} is determined,
a Frobenius norm ∥e^{k,n}∥=\sqrt{e^{k,n}e_{k,n}} of said error signal is determined;
the estimate F_{j,m}^{k,n} is determined that reduces or minimizes said Frobenius norm or any derivate thereof.

Pursuant to another embodiment, the estimate F_{j,m}^{k,n} is determined by utilizing an iterative algorithm, in particular by recursively applying a stochastic gradient algorithm.

According to an embodiment, the collaborative network element of the MIMO system comprises several transmitters, in particular several transceivers, associated with one collaboration area.

It is noted that said collaboration area may comprise several modems that are deployed within one CO, ONU and/or DSLAM. The components of a collaboration area could be utilized by multi-user coordination.

According to another embodiment, the transceivers are modems of a DSL environment or components of a wireless environment.

It is noted that DSL environment refers to any present and future digital subscriber line technique applicable, e.g., ADSL, ADSL2, ADSL2+, VDSL, VDSL2. The DSL environment may in particular provide Dynamic Spectrum Management (DSM) services.

A wireless environment may be supported by at least one base station (or cooperating base stations or network elements utilizing cooperative antennas).

In yet another embodiment, DMT or OFDM is utilized for conveying traffic in upstream and/or downstream direction.

According to a next embodiment, collaborative network elements are deployed at both sides of a communication network.

Hence, full overlap of a frequency band as well as no limits regarding the power reduction is required as NEXT can be efficiently reduced or compensated on both sides of the MIMO system.

The problem stated above is also solved by a device comprising and/or being associated with a processor unit and/or a hard-wired circuit and/or a logic device that is arranged such that the method as described herein is executable thereon.

According to an embodiment, said device is or is associated with a communication device, in particular a network element, a collaborative network element, a base station, a central office, a digital subscriber line access multiplexer, an optical network unit or any combination thereof.

The problem mentioned above is also solved by an interference canceller or pre-coding unit comprising a processing capability being arranged such that the method described herein is executable thereon.

The problem stated supra is further solved by a communication system comprising the device as described herein.

Embodiments of the invention are shown and illustrated in the following figures:

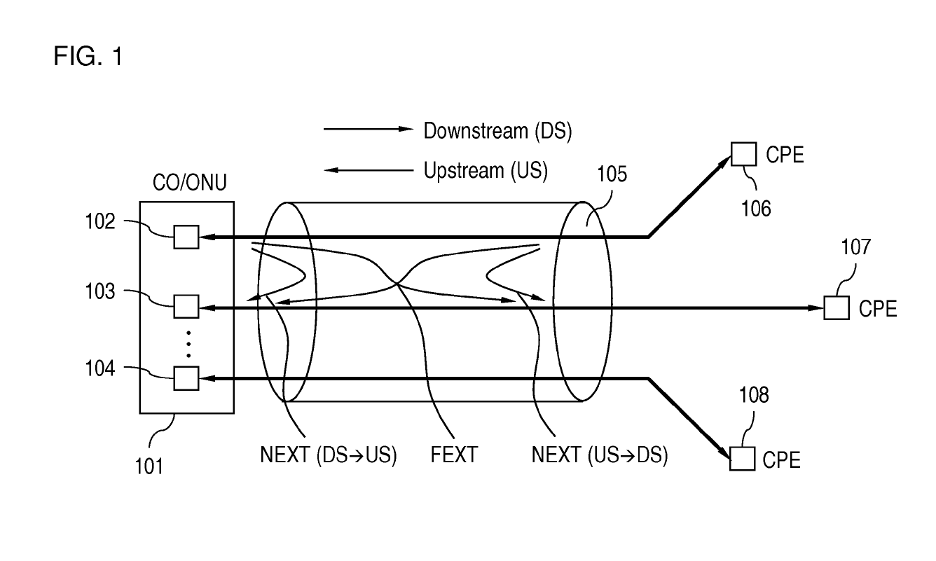

FIG. 1 shows a schematic diagram of a typical DSL configuration comprising a central office CO (which may be realized as an optical network unit ONU) comprising several modems, wherein said modems are connected via a cable binder to several customer premises equipments CPEs;

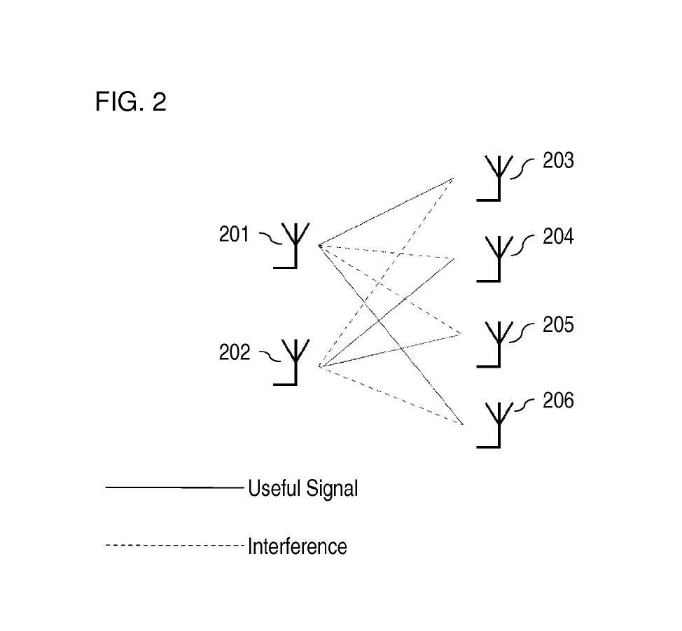

FIG. 2 shows a schematic diagram with various antennas depicting transmission and interference in a scenario with many users without any coordination;

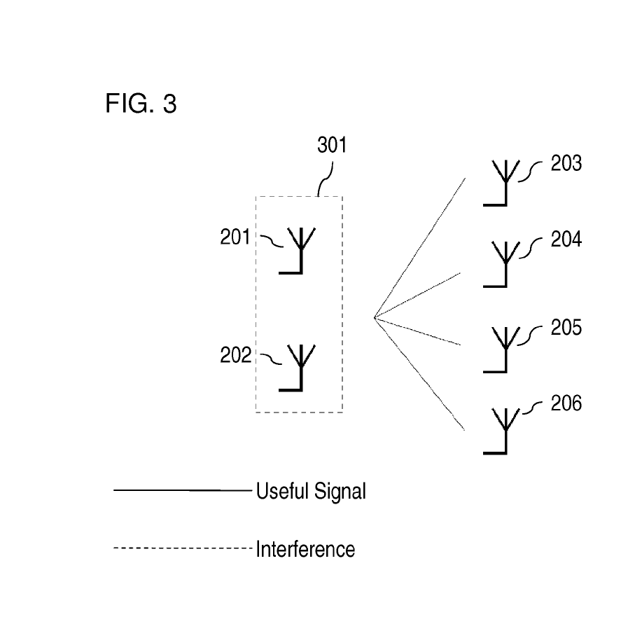

FIG. 3 shows a schematic diagram with various antennas depicting transmission and interference in a scenario with many users with coordination;

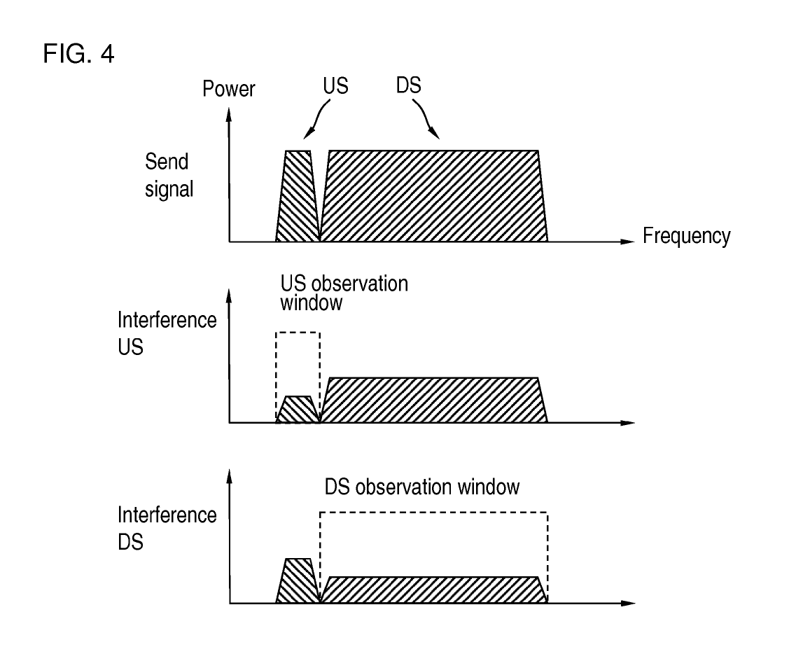

FIG. 4 shows power over frequency diagrams visualizing Frequency Division Duplexing comprising send signals and interference on US and DS receive signals;

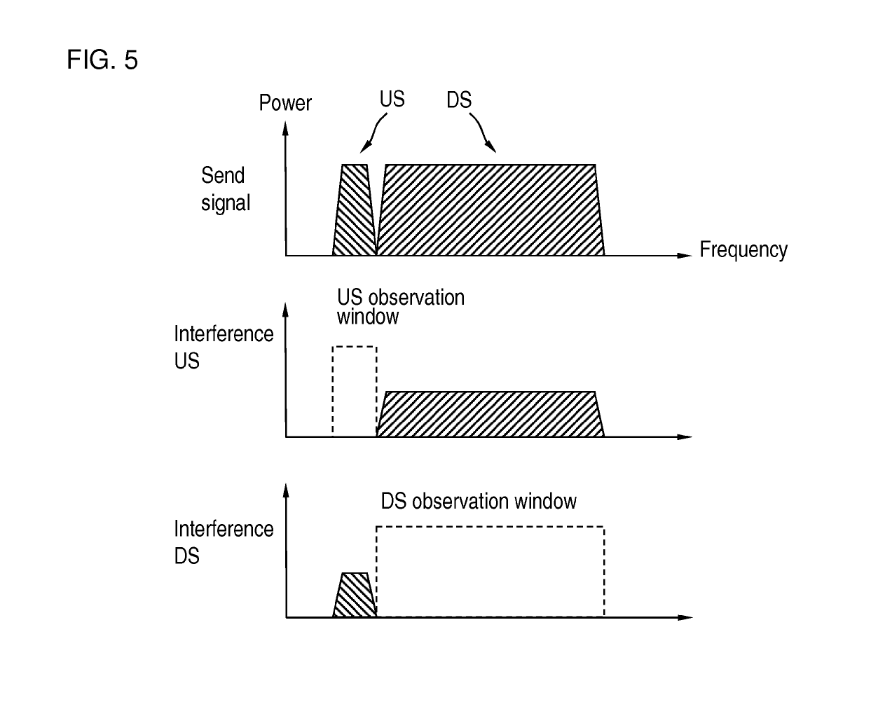

FIG. 5 shows power over frequency diagrams visualizing Frequency Division Duplexing with one-side collaboration, wherein FEI is completely cancelled;

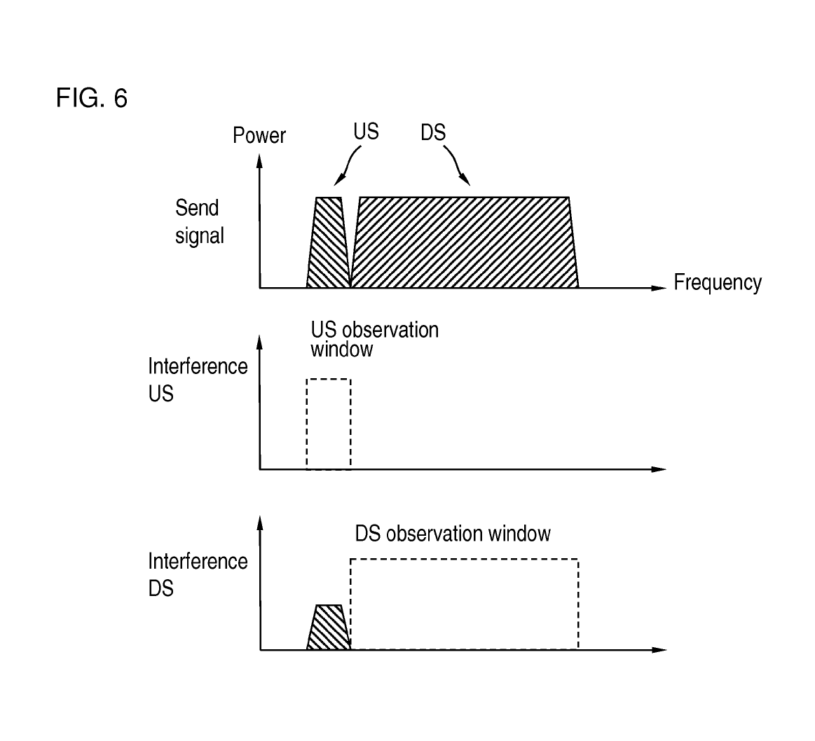

FIG. 6 shows power over frequency diagrams visualizing Frequency Division Duplexing with one-side collaboration and with tensor echo cancellation, wherein FEI is totally cancelled and NEI is cancelled in the US receive signal;

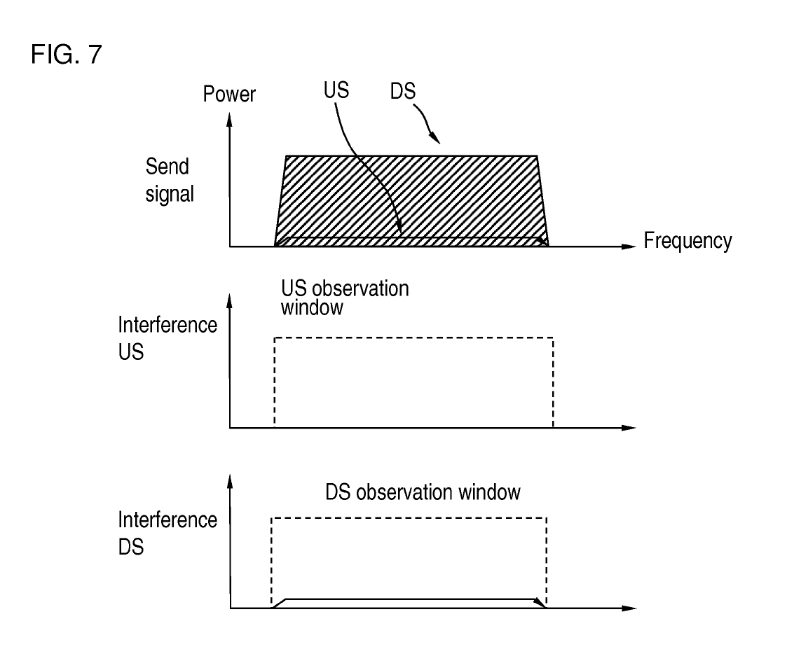

FIG. 7 shows power over frequency diagrams visualizing an overlapped transmission system with one-side collaboration and with a multi-user echo canceller, wherein FEI is totally cancelled and NEI is cancelled in the US receive signal. The spectral efficiency of US and DS is much higher compared to the FDD approach, wherein the total interference is not increased.

The solution provided herein suggests a new technique to implement multi-user echo cancellation, which may in particular be based on DSM L3.

Furthermore, a concept for allocating spectral power in a DSL transmission is suggested, said concept being based on said multi-user echo cancellation.

FIG. 1 shows a schematic diagram of a typical DSL configuration comprising a central office CO 101 (which may be realized as an optical network unit ONU) comprising several modems 102 to 104. The modems 102 to 104 of the CO 101 are connected via a cable binder 105 to several customer premises equipments CPEs 106 to 108. In particular, the modem 102 is connected to the CPE 106, the modem 103 is connected to the CPE 107 and the modem 104 is connected to the CPE 108.

Traffic conveyed from the CO towards the CPE is referred to as downstream (or downlink) traffic and traffic conveyed in the opposite direction, i.e. from the CPE to the CO is referred to as upstream (or uplink) traffic.

Far-end crosstalk (FEXT or FEI) is interference between two pairs in one cable measured at the end of the cable far-off from the transmitter. Near-end crosstalk (NEXT or NEI) is interference between two pairs in one cable measured at the end of the cable near(est) to the transmitter.

According to the current DSL concept, each modem 102 to 104 acts as an independent entity and has therefore an exact knowledge of its send signal and a stochastic knowledge of a receive signal. Such stochastic knowledge stems from the fact that the receive signal is affected by noise and/or interference.

According to DSM L3, a full cooperation of the DSM modems is provided at the CO 101. Hence, at the CO 101 each transmitter may have a complete and an exact knowledge not only of its own transmit signal, but also of transmit signals of the other modems within a DSM group.

This allows for a change of paradigm, i.e. from a single user scenario to a multi-user coordination.

With regard to a DSM group, a relative group of signals may be considered as a single multi-dimensional signal. Therefore NEXT, which in the single-user case is considered as interference from unknown signals, can be considered as an echo, i.e. a return of a portion of the multi-dimensional send signal on the multi-dimensional receive-signal. Thus, in the DSM L3 scenario, NEXT may be reduced to a multi-user echo. High-efficiency echo cancellation can be achieved if the sources of the echo are well known.

Due to DMT, a DSL transmission can be structured as a set of independent transmissions, each transmission conveyed on a

DMT sub-carrier. Hence, a channel model thereof can be assumed to be based on a per-carrier frequency-domain representation. In case of DSM L3 and because of a mutual dependency of different modems caused by interference, all such DSM modems may be considered together. Advantageously, still a per-carrier representation can be applied.

A channel model for a single carrier may be denoted as

y=H·u+E·d+n,

wherein
y is a receive signal vector at the CO,
u is an upstream send vector (to be decoded at the CO),
d is a downstream send vector,
n is a (multidimensional) noise,
H is a MIMO channel matrix for upstream transmission and far-end crosstalk (FEXT),
E is a matrix representing multi-user echoes, i.e.

the part of the downstream send signal that is reflected into the upstream receive signal.

In particular, elements on a main diagonal of the matrix E are reflection coefficients of the direct paths, whereas off-diagonal elements represent the NEXT transfer functions between pairs for the CO side (NEXT caused from the downstream signal on the upstream receive signal).

Considering that the signals in the send vector d are known, the NEXT component reflected may be removed due to a multi-user echo canceller determining a (multidimensional) signal y′:

y′=y−F·d=H·u+E·d−F·d+n

wherein
F is an estimate of the matrix E representing the multi-user echoes.

This estimate matrix F may be obtained via utilization of a MIMO-channel estimation algorithm like Least Mean Square (LMS), Least Square Algorithm (LSA), or Recursive Least Square (RLS).

Advantageously, estimating matrix E is straight forward as the vector d is known. In case the matrix F is close to the matrix E (i.e. in case of a rather correct estimation), the vector y′ can be denoted as

y′=y−F·d≈H·u+n

and almost all the echoes and NEXT are cancelled. Hence, decoding of the upstream send vector u using the vector y′ allows for a higher signal-to-noise ratio (SNR) than using the vector y.

As of an inherent lack of symmetry of the DSL system model (co-location appears at the CO/ONU side, whereas the CPEs are usually not deployed in a vicinity to each other), echo-cancellation may be applicable for upstream receive signals. Considering typical DSL applications, however, a downstream enhancement is of significant importance as a typical scenario implies that more traffic is conveyed towards the CPE than back to the CO.

In order to distribute the benefits of the echo-cancellation on both (upstream and downstream) transmission directions, a transmission technique different to FDD may be used.

In particular, NEXT caused from upstream to downstream (which may not be suppressed with DSM L3) shall be as small as possible, wherein the whole available frequency band shall be used for downstream transmission. Also—if possible—the whole available frequency band shall be used for upstream transmission.

Without utilizing FDD, NEXT (from upstream to downstream) can be reduced by reducing the transmission power of upstream signals. Nevertheless, a high upstream performance is striven for.

Hence, the concept suggested may provide a (full) band overlapping of low-power upstream signals and downstream signals of higher power (compared to the power of the upstream signals).

The upstream signals may be transmitted with low-power, as the SNR is enhanced by means of echo-cancellation. Furthermore, using the whole available bandwidth allows for a per-carrier power being significantly smaller than a power required in a comparable FDD scenario, although a given upstream target data-rate is comparable to the FDD scenario. Another advantage of the approach suggested is that the NEXT caused on downstream signals is still low and hence downstream transmissions indirectly benefit from the advantages of the multi-user echo canceller.

On the other hand, a high-power downstream signal does not interfere with the low-power upstream signal, because of the multi-user echo cancellation.

Advantageously, a multi-user echo canceller may utilize a frequency band of, e.g., 17-30 MHz.

Tensor-Echo Canceller

It is also an option to enable multiuser echo cancellation based on collaboration utilizing a tensor signal and a tensor echo-cancellation. An approach for allocating spectral power in a MIMO transmission system based on the aforementioned tensor echo-cancellation will be provided.

Collaboration is a significant feature of a MIMO system. Such collaboration allows shifting the conceptual paradigm from single-user (per-modem or per-antenna, in general per-user) to multi-user coordination or communication. Thus, a performance of the communications system can be improved by sending or receiving in a coordinated way.

FIG. 2 shows a schematic diagram with various antennas depicting transmission and interference in a scenario with many users without any coordination. An antenna 201 conveys a useful signal to an antenna 203 and to an antenna 206 and an antenna 202 conveys a useful signal to an antenna 204 and to an antenna 205. In addition to the useful signals, interference is introduced between the antenna 201 and the antennas 204 and 205 as well as between the antenna 202 and the antennas 203 and 206.

FIG. 3 shows a schematic diagram with various antennas depicting transmission and interference in a scenario with many users with coordination. The antennas are introduced in FIG. 2 above. However, in FIG. 3, the antennas 201 and 202 are grouped or coordinated (indicated by a block 301) and thus suppress (or reduce) interference by means of pre-processing and/or cancellation. Hence, based on such exemplary single-sided coordination, FEXT can be avoided (or reduced) by utilizing appropriate sending and/or decoding techniques that consider the multiple send and/or receive signals as a single multidimensional signal. In the single-user conception of FIG. 2, each sender/receiver operates as an independent entity and therefore merely knows about its own send signal and has a stochastic knowledge of the receive signal (such stochastic knowledge is based on the fact that the receive signal is affected by noise and/or interference).

However, according to the multi-user concept, an enhanced, in particular a full, cooperation of transmitters and/or receivers is provided at least on one side of the communication system. In case of DSM L3, cooperation can be applied on the CO/ONU side. For wireless systems, collaboration may be provided with the base station or via different base-stations. Herein, the side providing collaboration is referred to as CO (applicable for DSL), wherein this concept also applies for the wireless scenario (utilizing, e.g., base stations for collaboration purposes).

At the collaborative side, each transmitter may have full and (more or less exact) knowledge not only of its own transmit signal, but also of the transmit signal of (all) the other transmitters/receivers in the collaboration group. Hence, coordination is possible not only for a single user, but for several users. Therefore, the single send/receive signals turn to a single multi-dimensional signal, represented by a tensor.

In a basic case, the signal may be a two-dimensional tensor x^{j,m}. However, the signal may well be of higher dimension; in such case, the approach provided applies accordingly.

Herein, the notation and conventions typical for tensor-notation used in Physics, including the Einstein summation convention, are used.

Hence,

x^{j,m}

is a two-dimensional space-time or space-frequency tensor-signal, wherein
x is a two-dimensional send signal,
j is a contravariant index in the space domain, and
m is a contravariant index in the time or frequency domain.

In a full duplex scenario, there is a set of four signals:

x₍ᵤ₎^{j,m}, y₍ᵤ₎^{k,n}, x_{(d)}^{j,m}, y_{(d)}^{k,n}

wherein
x is the two-dimensional send signal,
y is the two-dimensional receiver signal,
(u) indicates an upstream direction, and
(d) indicates a downstream direction.

The contravariant representation chosen does not restrict the generality of this approach. A dual algorithm with covariant representation can be easily derived.

The collaboration may be feasible at the CO (or the base station in the wireless scenario). A channel input-output relationship can be set forth based on a multi-linearity of all involved channels. The signal x₍ᵤ₎^{j,m} sent from the non-collaborative side is distorted by a multilinear transformation described by a tensor H_{j,m}^{k,n}, which models the effect of the channel.

A second component is generated by the reflection of the signal x_{(d)}^{j,m} sent at the collaborative side, which is modulated by a second tensor E_{j,m}^{k,n} describing the reflection and the NEXT. Hence, a channel input-output relationship on the collaborative-side can be summarized as

y₍ᵤ₎^{k,m}=H_{j,m}^{k,n}·x₍ᵤ₎^{j,m}+E_{j,m}^{k,n}·x_{(d)}^{j,m}+n^{k,n},

This equation makes use of Einstein's summation convention. The tensor n^{k,n} represents a multi-dimensional additive white Gaussian noise.

At the collaborative side, the signal x_{(d)}^{j,m} is well known as it is the send signal conveyed in downstream direction.

Therefore, any distortion based on such signal may be removed at the collaborative side in case a multilinear transformation modeled by the tensor E_{j,m}^{k,n} can be determined or approximated.

An estimate tensor z^{k,n} amounts to

$$\begin{matrix}{z}_{( u )}^{k , n} = {y}_{( u )}^{k , n} - {F}_{j , m}^{k , n} \cdot {x}_{( d )}^{j , m} \\ = {H}_{j , m}^{k , n} \cdot {x}_{( u )}^{j , m} + ( {E}_{j , m}^{k , n} - {F}_{j , m}^{k , n} ) \cdot {x}_{( d )}^{j , m} + {n}^{k , n} \approx \\ \approx {H}_{j , m}^{k , n} \cdot {x}_{( u )}^{j , m} + {n}^{k , n} .\end{matrix}$$

With a decoding algorithm, the information contained in z^{k,n} may be determined.

A maximum likelihood decoding, a Viterbi algorithm or a minimum distance decoding could be utilized as decoding algorithm. As an example, the tensor signal z^{k,n} could be equalized based on the tensor H_{j,m}^{k,n} followed by a decoding via quantization.

As the noise created by the reflection signal has been subtracted, the efficiency in decoding is much higher than without echo cancellation. This additional efficiency may be utilized, e.g., by transmitting at a higher data-rate, by transmitting at a reduced energy and/or with reduced bit error rate (BER), or by any combination thereof.

An estimate tensor F_{j,m}^{k,n} of the tensor E_{j,m}^{k,n} can be determined based on an adaptation of a stochastic gradient algorithm to multidimensional problems. A tensor error-signal is defined describing a residual error after the echo-cancellation:

e^{k,n}=F_{j,m}^{k,n}·x^{k,m}−E_{j,m}^{k,n}·x^{j,m},

A Frobenius norm of the tensor signal amounts to:

∥e^{k,m}∥=\sqrt{e^{k,n}e_{k,m}}.

Next, a tensor F_{j,m}^{k,n} is determined that minimizes said Frobenius norm. Actually, the solution provided may minimize the square of the Frobenius norm, which is deemed equivalent to minimizing the norm itself.

Using a common optimization technique, a partial derivative of the Frobenius norm of the error is determined with respect to each element of the tensor F_{j,m}^{k,n} and a gradient of ∥e_{j,m}^{k,n}∥² is determined (said gradient being, e.g., a tensor of the same dimension as F_{j,m}^{k,n}),

As a common optimization technique, a derivate could be determined and this derivative can be set to zero to find a maximum or a minimum. It is also possible to minimize a remaining error. In particular, a stochastic gradient algorithm can be used to successively determine an optimized solution.

The optimized solution is determined by setting the gradient to zero. In order to solve the resulting system of equations, a number of different techniques could be applied. For example, a stochastic gradient algorithm can be adopted. In order to correctly express the recursive solution to the problem, a left-side index can be added denoting the iteration number. Hence, an updated equation may be the following recursive equation

_{q+1}F_{j,m}^{k,n}=_{q}F_{j,m}^{k,n}−μ_{q}x_{j,m}^{x}_{q}e^{k,n},

Thus, the approach of echo cancellation may advantageously be utilized on upstream receive signals (at a CO in a DSL scenario or at a base station in a wireless environment). As discussed above, this approach can nevertheless efficiently be utilized also for downstream system performance purposes.

Visualization: From FDD to Overlapping Frequency Bands with Echo Cancellation

FIG. 4 shows power over frequency diagrams visualizing Frequency Division Duplexing comprising send signals and interference on US and DS receive signals.

FIG. 5 shows power over frequency diagrams visualizing Frequency Division Duplexing with one-side collaboration, wherein FEI is completely cancelled.

FIG. 6 shows power over frequency diagrams visualizing Frequency Division Duplexing with one-side collaboration and with tensor echo cancellation, wherein FEI is totally cancelled and NEI is cancelled in the US receive signal.

FIG. 7 shows power over frequency diagrams visualizing an overlapped transmission system with one-side collaboration and with a multi-user echo canceller, wherein FEI is totally cancelled and NEI is cancelled in the US receive signal. The spectral efficiency of US and DS is much higher compared to the FDD approach, wherein the total interference is not increased.

In order to distribute the benefits of the echo-canceller on both transmission directions, a transmission technique different from FDD (FIG. 4) is suggested. In particular, NEI caused from US to DS (which may not be suppressed with one-side collaboration, as shown in FIG. 5 and FIG. 6) shall be as small as possible, but still the whole available frequency band may be used for DS transmission and - if possible - also for US transmission.

Without utilizing FDD, NEXT (from upstream to downstream) can be reduced by reducing the transmission power of upstream signals. Nevertheless, a high upstream performance is striven for. Hence, the concept suggested provides a full band overlapping of low-power upstream signals and higher-power downstream signals as shown in FIG. 7.

The upstream signals may be transmitted with low-power, as the SNR is enhanced by means of echo-cancellation. Furthermore, using the whole available bandwidth allows for a per-carrier power being significantly smaller than a power required in a comparable FDD scenario, although a given upstream target data-rate is comparable to the FDD scenario. Another advantage of the approach suggested is that the NEXT caused on downstream signals is still low and hence downstream transmissions indirectly benefit from the advantages of the multi-user echo canceller.

On the other hand, a high-power downstream signal does not interfere with the low-power upstream signal, because of the multi-user echo cancellation.

Furthermore, a promising application of the echo-canceller could be a multi-antenna/multi-user system with collaboration on both sides providing an overlapping of frequency bands with limited or without any power reduction.

Further Advantages

This solution can be implemented in hardware and/or software. In case of high-performance hardware, an implementation on a software level may be of advantage, e.g., with the software of a DSM L3 controller or with the software of a DSLAM.

The approach allows for an enhanced spectral efficiency of DSL systems and improves the performance in upstream and downstream directions. An upgrade or a modification on the collaborating side, e.g., at the CO or ONU, can be easily conducted, hardware changes are not required.

### LIST OF ABBREVIATIONS

BER Bit Error Rate

BS Base Station

CO Central Office

CPE Customer Premise Equipment

DMT Discrete Multi-Tone modulation

DS Downstream / Downlink Signal

DSL Digital Subscriber Line

DSLAM Digital Subscriber Line Access Multiplexer

DSM L3 Dynamic Spectrum Management Level 3

FDD Frequency Division Duplexing

FEI Far-End Interference

FEXT Far-End Crosstalk

IFT Inverse Fourier Transform

LMS Least Mean Square

LSA Least Square Algorithm

MIMO Multiple Input Multiple Output

NEI Near-End Interference

NEXT Near-End Crosstalk

OFDM Orthogonal Frequency Division Multiplexing

ONU Optical Network Unit

RLS Recursive Least Square

SNR Signal-to-Noise Ratio

US Upstream / Uplink Signal

xDSL various kinds of DSL

1-15. (canceled)

16. A method for data processing in a network element of a multiple-input-multiple-output (MIMO) system, which comprises the steps of:
reducing near end cross talk at a collaborative network element of the MIMO system; and
at least partially using a frequency band for upstream and downstream traffic.

17. The method according to claim 16, which further comprises completely using the frequency band for the upstream and downstream traffic.

18. The method according to claim 16, which further comprises conveying the upstream traffic with a reduced power compared to the downstream traffic.

19. The method according to claim 16, which further comprises reducing the near end cross talk by determining an estimate of multi-user echoes, including by determining an estimate of at least one downstream send signal that is reflected into at least one upstream receive signal.

20. The method according to claim 19, which further comprises determining the estimate of multi-user echoes based on an estimate F_{j,m}^{k,n} of multi-user echoes E_{j,m}^{k,n} based on a stochastic gradient algorithm.

21. The method according to claim 19, which further comprises:
determining an error signal E^{k,n}=F_{j,m}^{k,n}, x^{j,m}−E_{j,m}^{k,n}, x^{j,m};
determining a Frobenius norm ∥e^{k,n}∥=\sqrt{e^{k,n}e_{k,n}} of the error signal; and
determining an estimate F_{j,m}^{k,n} that reduces or minimizes the Frobenius norm or any derivate thereof.

22. The method according to claim 21, which further comprises determining the estimate F_{j,m}^{k,n} by utilizing an iterative algorithm.

23. The method according to claim 16, wherein the collaborative network element of the MIMO system contains several transmitters associated with one collaboration area.

24. The method according to claim 23, wherein the transmitters are modems of a digital subscriber line (DSL) environment or components of a wireless environment.

25. The method according to claim 16, wherein discrete multi-tone (DMT) or orthogonal frequency division multiplexing (OFDM) is utilized for conveying traffic in upstream and/or downstream direction.

26. The method according to claim 16, which further comprises deploying collaborative network elements at both sides of a communication network.

27. The method according to claim 23, which further comprises providing several transceivers as the several transmitters.

28. The method according to claim 21, which further comprises determining the estimate F_{j,m}^{k,n} by recursively applying a stochastic gradient algorithm.

29. A device, comprising;
at least one of a processor unit, a hard-wired circuit or a logic device programmed to perform a method for data processing in a network element of a multiple-input-multiple-output (MIMO) system, which comprises the steps of:
reducing near end cross talk at a collaborative network element of the MIMO system; and
at least partially using a frequency band for upstream and downstream traffic.

30. The device according to claim 29, wherein the device is selected from the group consisting of a communication device, a network element, a collaborative network element, a base station, a central office, a digital subscriber line access multiplexer, an optical network unit and any combination thereof.

31. An interference canceller or pre-coding unit, comprising:
a processor programmed to perform a method for data processing in a network element of a multiple-input-multiple-output (MIMO) system, which comprises the steps of:
reducing near end cross talk at a collaborative network element of the MIMO system; and
at least partially using a frequency band for upstream and downstream traffic.

32. A communication system, comprising:
a device selected from the group consisting of a processor unit, a hard-wired circuit and a logic device, said device programmed to perform a method for data processing in a network element of a multiple-input-multiple-output (MIMO) system, which method comprises the steps of:
reducing near end cross talk at a collaborative network element of the MIMO system; and
at least partially using a frequency band for upstream and downstream traffic.
